(19) United States
(12) Patent Application Publication
(10) Pub. No.: US 2008/0251157 A1
(43) Pub. Date: Oct. 16, 2008

(54) Tree and stump trimming and removal system

(76) Inventor: Todd Alan Mason, Firth, NE (US)

Correspondence Address: VINCENT L. CARNEY LAW OFFICE, P.O. BOX 80836, LINCOLN, NE, 68501-0836, US

(21) Appl. No.: 11/977,985

(22) Filed: Oct. 26, 2007

Related U.S. Application Data
(62) Division of application No. 11/786,170, filed on Apr. 11, 2007.

(51) Int. Cl. A01G 23/00

(52) U.S. Cl. 144/343; 144/24.12; 144/24.13; 241/28; 241/282.2

(57) ABSTRACT

A novel tree trimming system includes a crane which lifts a wood working implement and a tree trimmer together over obstacles if necessary to a location where a tree is to trimmed. The tree trimmer may cut limbs and feed them directly into the wood working implement that is mounted just beneath him or may drop them to the ground or fasten them to holders that have been lifted with the tree trimmer by the crane. On the ground, a cart which may be motor driven by hydraulic motors or manually moved or pulled by another vehicle can be retracted to fit through ordinary garden gates. The retraction may include moving the wheels or tracker treads of the cart together and moving the hydraulic motor outside of the space between tractor treads so that the tractor treads may be moved closer together. Moreover, side members may be folded upwardly to compress material on the top of the cart and extensions moved in place at the front and end of the cart to increase load carrying capacity. A stump grinder includes an enclosure to control the chips and powder and a vacuum to pull the chips and powder into a container.

### RELATED CASES

This application is a divisional of U.S. application Ser. No. 11/786,170 filed Apr. 11, 2007, entitled TREE AND STUMP TRIMMING AND REMOVAL SYSTEM by inventor, Todd Alan Mason.

### BACKGROUND OF THE INVENTION

This invention relates to tree and tree stump trimming and removal systems including the chipping and grinding of tree parts and stumps and the attendant operations such as the clean up and final grading.

It is known to use cranes and cherry pickers to aid in trimming trees. Moreover, it is known from U.S. Pat. No. 6,398,140 B1, to mount both a cherry picker and a wood working implement on a truck for use in tree trimming and other lawn care.

The use of a cherry picker and a wood working implement on a truck has some advantages but fails to address several problems related to tree trimming and removal and stump removal and trimming. Some of the shortcomings of cherry pickers are a result of their limited reach and degrees of freedom of motion. For example, as the vertical height of the boom increases the horizontal reach decreases. More specifically, this arrangement has several disadvantages, such as: (1) the cherry picker is not able to reach trees at some more distant locations such as in the back yard of a house; (2) it is difficult to reach some locations in a tree because of the limited freedom of motion of the cherry picker and the interference with branches; (3) the cherry picker cannot reach over some obstacles to reach a tree; (4) there is no cost effective provision for removing the tree limbs or portions of tree limbs that are trimmed from a tree in a more distant location such as a back yard; (5) there is no provision for removing tree stumps safely; (6) the cost of moving limbs that are trimmed and dropped to the ground to a truck and cleaning the ground beneath the tree is higher than it needs to be; (7) there is no provision for preventing or minimizing damage to landscape with low labor costs; and there is no provision for significantly reducing the labor needed for clean up for tree trimming operations and stump removal operations; and (8) because of the inability of the cherry picker to rotate its boom, much time is lost repositioning the cherry picker to reach and remove different limbs.

It is also known to mount a wood working implement on a crane with provisions for moving tree trunks to the wood working implement. However, this apparatus has the disadvantage of having no provision for trimming and removing tree limbs and chipping them immediately.

Wood working implements are known with a feedstock inlet, a chipping or shredding drum or disk and a feed drum. In these wood working implements, tree limbs or logs are fed into the inlet and the feed drum moves the limbs or logs to the chipping or shredding drum or disk. A prior art type of chipping or shredding drum or disk includes knives spaced to rotate with the drum or disk and chip the feedstock. This prior art type of wood working implement having knifes has several disadvantages such as being excessively subject to wear and requiring under some circumstances a relative slow rate of rotation of the chipping or shredding drum. Another prior art type of chipping or shredding drum includes hammers on the rotating drum that impact the feedstock while the feedstock is between the hammer and an anvil. This type of chipping or shredding apparatus has the disadvantage of being heavy, requiring a high torque motor, or under some circumstances, requiring a low rotational velocity and not providing uniform output chips. It is known to use saw discs with teeth mounted on the edge of the discs. The teeth have a substantially square cross section with corners shaped to cut into the wood. These teeth have not been adapted for chipping and grinding in the tree trimming environment.

It is known to remove tree limbs and other disposable tree parts in a wheeled cart or the like. The prior art carts for this purpose have had the disadvantages of not being able to move a sufficient amount of material because of their narrow size or being expensive or difficult to use because of their excessive length and inability to easily balance loads using balanced leverage

It is known to remove tree stumps by grinding the stumps in place. The prior art tree stump removers have a disadvantage in that they leave an excessive amount of wood chips or other parts of the stump at locations around the former stump. This causes an expensive loss of time in cleaning the area and introducing new dirt to fill the stump hole.

### SUMMARY OF THE INVENTION

Accordingly, it is an object of the invention to provide a novel method and apparatus for tree care.

It is a further object of the invention to provide a novel method and apparatus for removing trees and parts of trees.

It is a still further object of the invention to provide a novel method and apparatus for removing trees and parts of trees with minimum effect on the land surrounding the trees or parts of trees.

It is a still further object of the invention to provide a novel method for tree trimming at locations that are relatively inaccessible.

It is a still further object of the invention to provide a tree trimming technique that is applicable to sites in which all of the work is to be done at a location in which access is difficult, at sites where some of the work is to be done at a location that is relatively inaccessible and some that is readily accessible and at locations in which all of the work is to be done at a relatively accessible location.

It is a still further object of the invention to provide a novel wood chipping apparatus.

It is a still further object of the invention to provide a novel technique for trimming trees with a minimum amount of time and labor spent cleaning up the location after the tree has been trimmed.

It is a still further object of the invention to provide a novel apparatus for trimming trees and removing the limbs by chipping or carrying them from the site.

It is a still further object of the invention to provide a novel tree trimming technique which is particularly flexible to accommodate different locations and different types of work to be done at the location.

It is a still further object of the invention to provide a novel chipping drum and chipping tooth.

It is a still further object of the invention to provide a novel cart for removing tree parts.

It is a still further object of the invention to provide a novel technique for removing tree parts after tree trimming at a location in which all of the access routes are limited in width.

It is a still further object of the invention to provide a novel stump removal technique which reduces the time required to clean up the area after a stump has been removed.

It is a still further object of the invention to provide a novel tree trimming and removal system that increases the safety of workers.

### BRIEF DESCRIPTION OF THE DRAWINGS

The above and further features of the invention will be better understood from the following detailed description when considered with reference to the accompanying drawings in which:

FIG. 1 is a simplified perspective drawing of a crane and wood working implement in accordance with an embodiment of an invention;

FIG. 2 is a simplified perspective view of a crane and wood working implement in accordance with another embodiment of the invention;

FIG. 3 is a perspective view of a wood working implement in accordance with an embodiment of the invention;

FIG. 4 is a simplified view of a cherry picker and wood working implement in accordance with an embodiment of the invention;

FIG. 5 is a simplified perspective view illustrating the use of a wood working implement suspended from a crane or cherry picker in accordance with an embodiment of the invention;

FIG. 6 is another simplified view of another embodiment illustrating the use of a crane in tree trimming;

FIG. 7 is a perspective view of a carriage as may be used in accordance with the embodiment of FIG. 6;

FIG. 8 is another embodiment of wood working implement and crane mounted tree trimmer station in accordance with still another embodiment of the invention;

FIG. 9 is a simplified perspective view of another embodiment of the invention illustrating a use of a crane or cherry picker;

FIG. 10 is a simplified perspective view of a wood working implement as used in one embodiment of the invention;

FIG. 11 is a simplified perspective view another embodiment illustrating the use of a wood working implement to easily remove limbs of a tree;

FIG. 12 is a simplified perspective view of a removal apparatus in accordance with the embodiment of FIG. 11 illustrating another position in the use of the apparatus of FIG. 11;

FIG. 13 is a simplified perspective view of an embodiment of apparatus for removing limbs or other debris utilizing a crane;

FIG. 14 illustrates a different position of the apparatus of FIG. 13 for removing limbs;

FIG. 15 is a simplified perspective view of an apparatus for treating the ground after tree trimming to restore its appearance;

FIG. 16 is a flow diagram illustrating the process of using the embodiments of the invention;

FIG. 17 a flow diagram of a process for trimming and removal of trees and tree parts where the work is to be done to a tree or trees that are in an inaccessible location for tree trimming;

FIG. 18 is a flow diagram showing a system for trimming and removal of trees and tree parts at inaccessible locations;

FIG. 19 is a flow diagram illustrating the steps for trimming and removal of tree parts at inaccessible locations;

FIG. 20 is a flow diagram illustrating the steps involved in trimming and removal of trimmed tree parts for locations which are partly accessible and partly inaccessible;

FIG. 21 is a flow diagram illustrating the steps for trimming and removal of tree parts at locations that are entirely accessible;

FIG. 22 is a fragmentary exploded perspective view of a novel chipper in accordance with the embodiment of the invention;

FIG. 23 is a fragmentary perspective view of a novel chipping drum in accordance with the embodiment of the invention;

FIG. 24 is a fragmentary simplified side view of the chipper of FIG. 22;

FIG. 25 is a simplified side view of the chipper of FIG. 22;

FIG. 26 is a simplified top view of the chipper of FIG. 22;

FIG. 27 is simplified perspective view of a novel cart for removing trimmed tree parts;

FIG. 28 is a simplified, fragmentary exploded view of the cart of FIG. 27;

FIG. 29 is a fragmentary side elevational view of the cart of FIG. 27;

FIG. 30 is a fragmentary front view of another embodiment of cart;

FIG. 31 is a fragmentary simplified bottom view of the cart of FIG. 27; and

FIG. 32 is a simplified fragmentary elevational view of a stump grinder or chipper in accordance with an embodiment of the invention.

### DETAILED DESCRIPTION

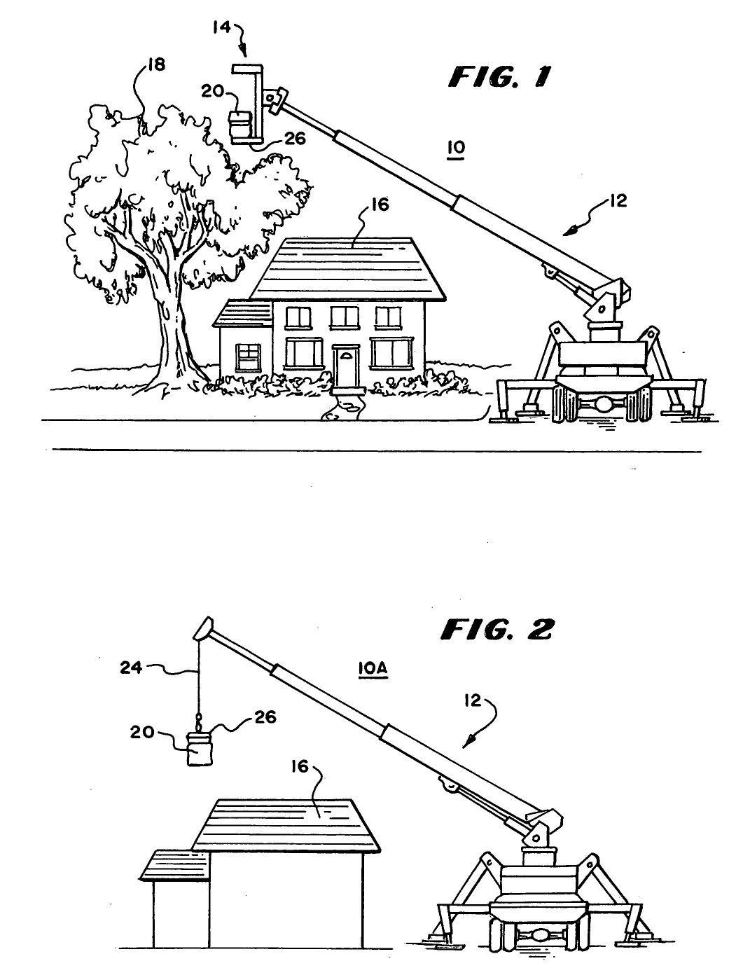

In FIG. 1, there is shown a simplified perspective view of one embodiment of a system 10 for trimming and removing trees and stumps having a lift 12, a tree trimmer station 14, a typical obstacle 16 and a tree 18. The tree trimmer station 14 may include a chipper or other wood working implement 20 and provide a place for a tree trimmer (not shown in FIG. 1) stand. The lift 12, the tree trimmer station 14 and the chipper or other wood working implement 20 are arranged so that the lift 12 positions the tree trimmer station 14 and the chipper 20 at a selected location. The lift 12 is able to position the tree trimmer station 14 and chipper 20 adjacent to a tree so that limbs may be removed by a tree trimmer who is on the tree trimmer station 14 and fed into the chipper 20 without the tree trimmer needing to leave the tree trimmer station 14 and without the lift 12 needing to move either the chipper 20 or tree trimmer station 14 to a new location such as to a vehicle before chipping wood. As shown in FIG. 1, the lift 12 may position the tree trimmer station 14 and chipper 20 over an obstacle such as the house 16 to obtain access to a tree such as that shown at 18 on the other side of the obstacle. In this specification, the words, “wood working implement” means chipper, grinder or abrader.

In the preferred embodiment, the lift 12 is a crane with a telescoping boom and a winch and the chipper 20 is a drum type chipper. The crane is the preferred lift because it can provide the height and reach to pass above and beyond obstacles with a sufficiently long boom and yet lower the chipper and tree trimmer to a selected height for work on a tree with a winch. A drum type chipper is the preferred wood-working implement because of its relatively small size and ability to reduce limbs or portions of the trunk of a tree to chips in place. As shown in this view, the crane 12 may extend over the house 16 which is an obstacle between it and the tree 18 to permit a tree trimmer stationed in the tree trimmer station or mount 14 to cut limbs and drop them into the chipper 20 for chipping and collection below to avoid the need to pick up and cart limbs to the street. In the embodiment of FIG. 1, a winch is not used.

In FIG. 2, there is shown another embodiment of system 10A for trimming and removing trees and stumps including a chipper mount 26 suspended from a crane winch load line 24 so that the tree trimmer (not shown in FIG. 2) on a tree trimmer station or mount 14 may be lowered into position on a tree. With this embodiment, a chipper 20 and person can be moved to different elevations by the winch through the winch load line 24 and be moved different distances over an obstacle 16 by the crane 12.

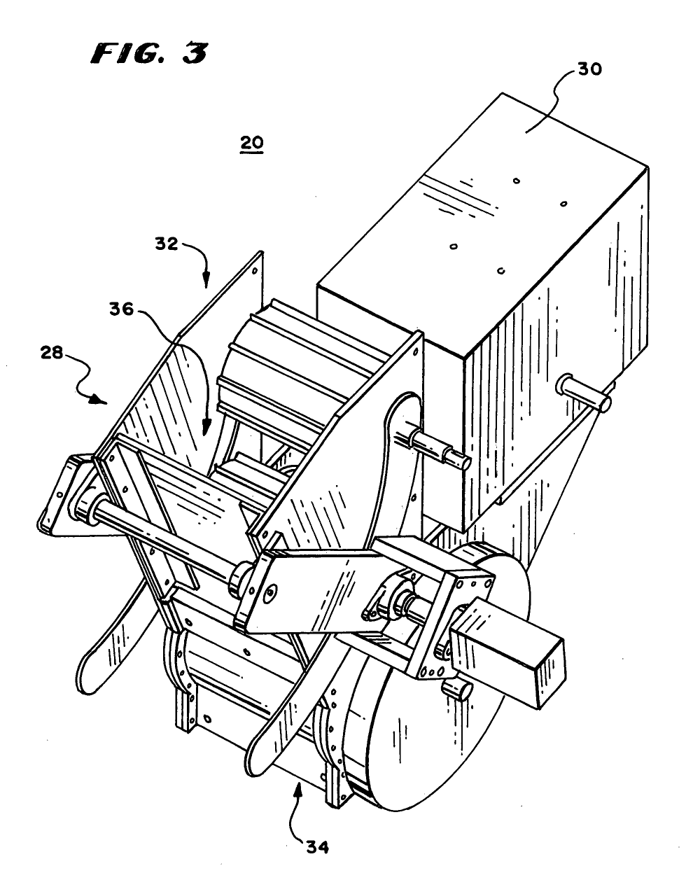

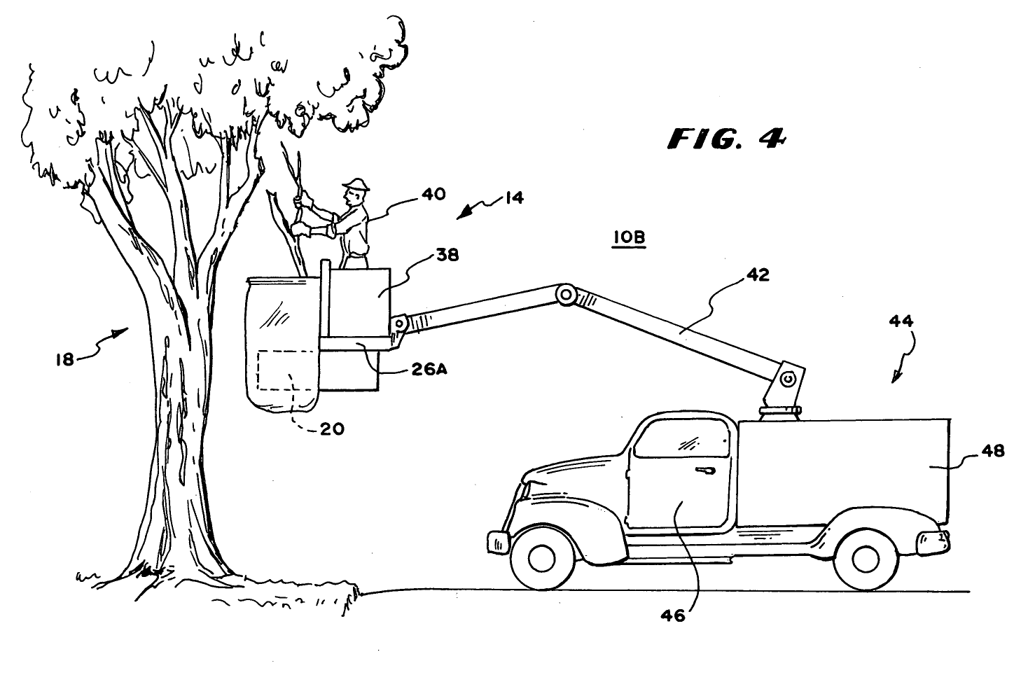

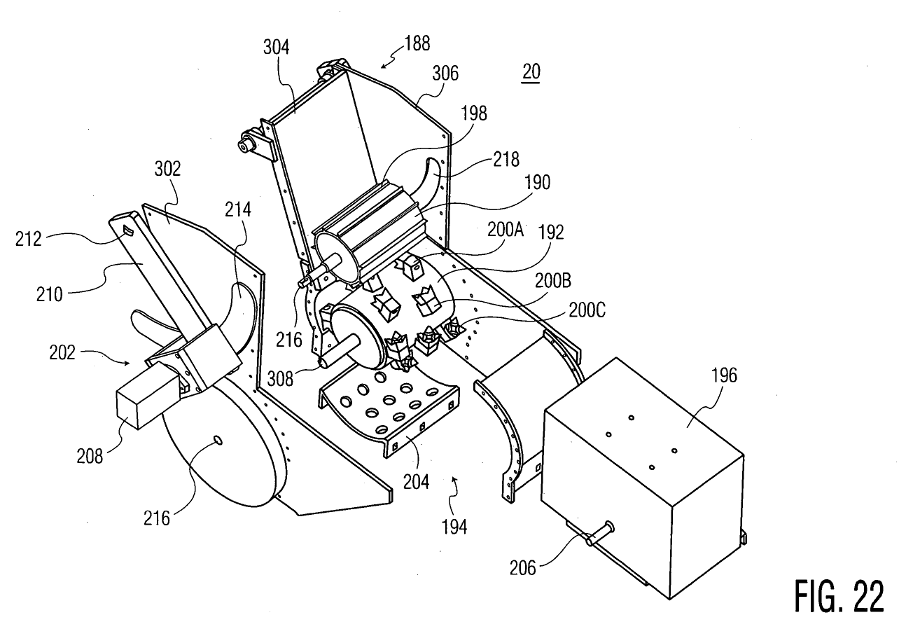

In FIG. 3, there is shown a perspective view of the chipper 20 having a drive mechanism 30, a feed inlet 32 for a chipper mechanism 28 and a discharge outlet 34. With this arrangement, limbs may be fed into the inlet 32 to be chipped and chips dropped from the outlet 194 (not shown in FIG. 3, shown in FIG. 22) at a location where the tree trimmer and the chipper are being moved for trimming the tree. In one embodiment, the person trimming the tree will stand on the drive mechanism 30 of the chipper 20 to cut limbs and feed them into the chipper feed inlet 32. Between the feed inlet 32 and the outlet 34, is a tooth drum section 36, which in the preferred embodiment, utilizes teeth inserted into rotating drums to reduce the limbs fed into the feed inlet 32 to chips which may be more easily disposed of.

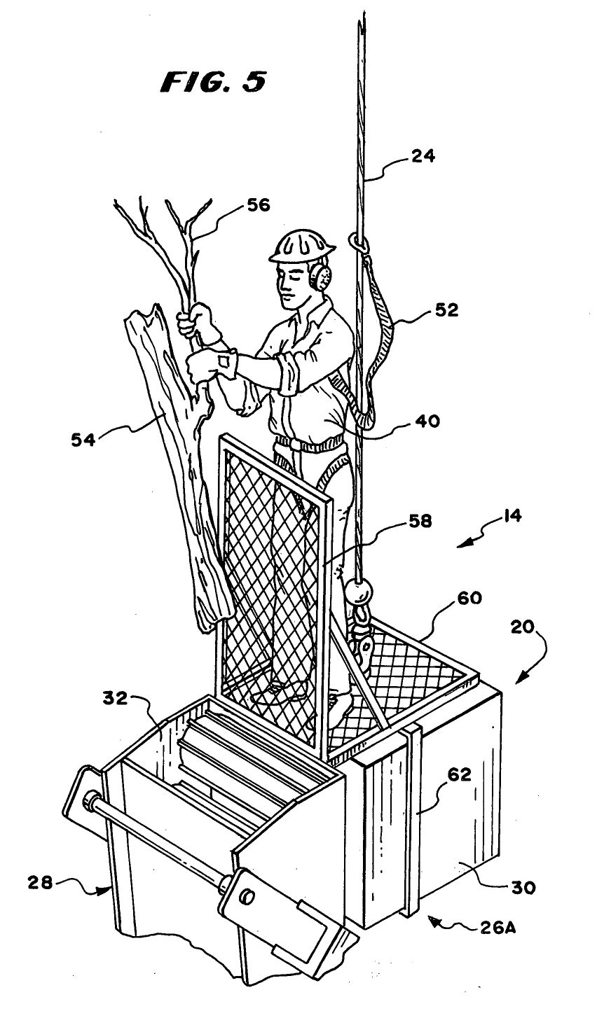

In FIG. 4, there is shown another embodiment 10B of a system for trimming and removing trees and stumps which utilizes a chipper 20 with a typical bucket 38 for a tree trimmer 40 and an hydraulic lift 42 mounted to a truck 44. The hydraulic lift 42 may be operated by the trimmer 40 in the tree or by a person in a cab 46 of the truck 44. In this embodiment, limbs may be reduced to chips by the chipper 20 that is also mounted near or adjacent to the bucket 38 so that the trimmer 40 can drop limbs in it. The sections of the logs that are remaining when the limbs are removed may be dropped in the bed 48 of the bucket truck 44. Moreover, instead of chipping the limbs with a chipper 20 on the bucket 38, limbs may be dropped into the bed 48 of the truck 44 for chipping at another location or within the truck.

In FIG. 5, there is shown a simplified perspective view of a tree trimmer station 14, a crane winch load line 24 and a tree trimmer 40. The tree trimmer station 14 and the winch load line 24 are connected to permit the winch load line 24 and winch (not shown in FIG. 5) to support and move the tree trimmer station 14. In the embodiment of FIG. 5, the tree trimmer station 14 includes a tree trimmer platform 60, a chipper mount 26A and chipper 20 with a tree trimmer guard 58 mounted vertically on top of the drive 30 of the chipper 20. The tree trimmer platform 60 is directly supported by a winch load line 24 mounted to the chipper drive mechanism 30 by straps 62 and supported therefrom. A person 40, who may be a tree trimmer or operator, is shown trimming limbs 56 from a log 54 for feeding into the feed inlet 32 to reduce the limbs to chips. The log 54 may then be dropped to the ground or loaded at a different location by moving the winch load line 24 at the end of a crane such as the crane 12 shown in FIG. 1.

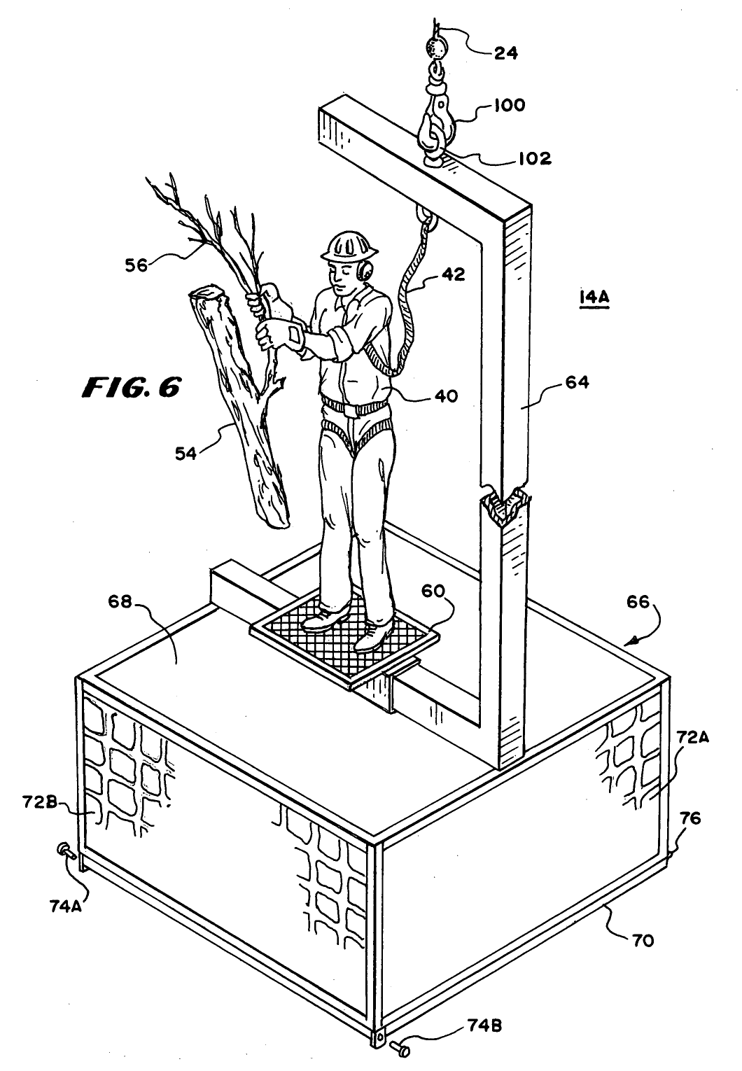

In FIG. 6, there is shown still another embodiment of tree trimmer station 14A. Unlike the tree trimmer station 14 of FIG. 5, the chipper 20 is not mounted adjacent to the tree trimmer station 14 but a branch holder 66 is mounted underneath the tree trimmer platform 60. The operating platform 60 instead of being mounted to the chipper is mounted within a frame, which in the embodiment of FIG. 6, is a C-shaped support formed of steel channels and connected at its upper portion to a ring connected or welded by some other mechanism to the C-frame support 64. The winch load line 24 engages the ring by the winch load line hook 100 to move it from place to place.

With this arrangement, the tree trimmer 40 may remove limbs such as the limb 56 from a log such as the log 54 and drop the limb into the open top 68 of the branch holder 66. A safety harness 42 may be worn by the tree trimmer to support him in the event of falling. The safety harness 42 may be fastened to the frame 64, which is a C-channel in the embodiment of FIG. 6 or directly to an extension of a ring 102 or to the winch load line 24 itself. The branch holder 66, in addition to having the open top 68, is enclosed by four sides 72A-72D. (only 72A and 72B being shown in FIG. 6). It has an openable bottom 70, which in the preferred embodiment is hinged. The bottom may thus be opened to drop the branches in a truck or near a chipper or to carry them to a location where they can be fed into a chipper directly from the branch holder 66.

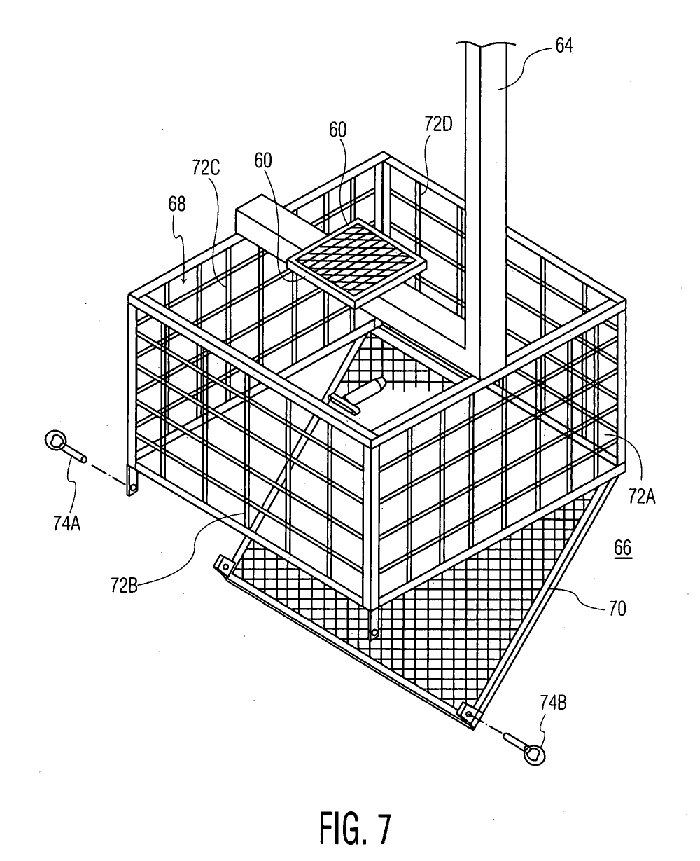

In FIG. 7, there is shown another view of the branch holder 66 with the frame 64, which in the embodiment of FIG. 7, is a C-support, and the tree trimmer platform 60. The branch holder 66 is shown with the bottom 70 being partly opened about a hinge 76 (not shown in FIG. 7, see FIG. 6) and showing latch pins 74B and 74A exploded away. As best shown in this embodiment, the hinged bottom 70 may be closed to receive branches and the pins 74A and 74B utilized to hold the bottom in place. Limbs may then be dropped with small loose parts falling through a grating in the bottom 70 or through the sides 72A-72D which are also in the form of a strong grate. In the preferred embodiment, the grate may be made of steel but could be made of any other sturdy material such as tarpaulin.

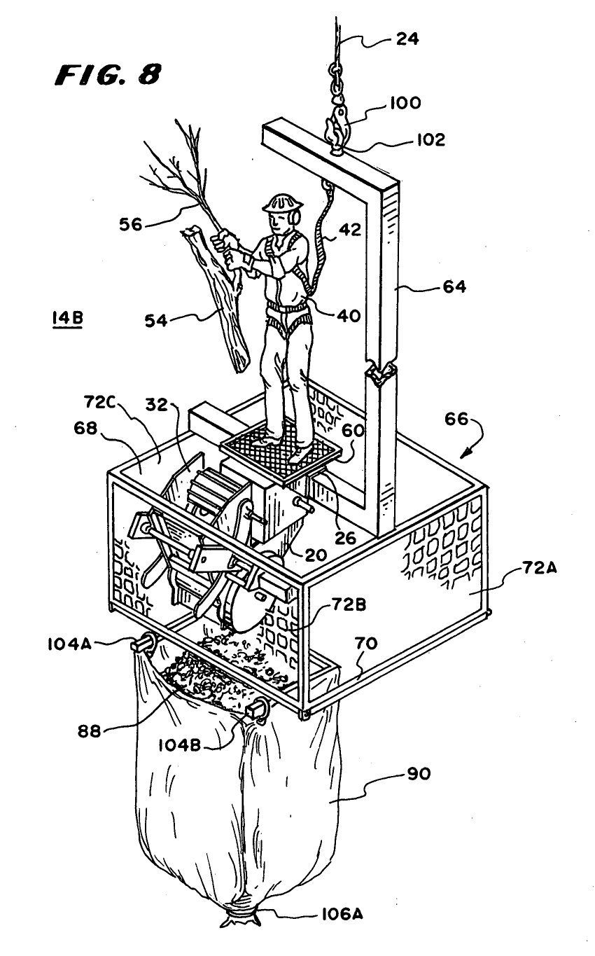

In FIG. 8, there is shown still another embodiment of tree trimmer station 14B including as its principal parts, a chipper mount 26, a limb holder 66, a tree trimmer platform 60, a frame 64 and a chip containment bag 90. A tree trimmer 40 wearing a safety harness 42 may stand on the trimmer platform 60. The trimmer platform is supported on the C-support 64, which is in turn supported a ring 102 and a winch load line 24 with its hook 100 engaging the ring 102. However, as shown in this view, the chipper 20 is mounted to the C-support 64 by a chipper support with the feed inlet 32 being positioned to receive limbs trimmed by the trimmer 40 from a log 54 and the chip containment bag 90 positioned under the outlet of the chipped to collect chips. In this embodiment, chips may be collected in the chip containment bag 90 or be permitted to fall through the bottom 70 of the limb holder 66. Similarly, logs 54 may be dropped into the limb holder so that a crane may remove them to a more convenient location or they may be dropped to the ground for later removal. If chips are permitted to fall to the ground, the chips may be spread over the ground.

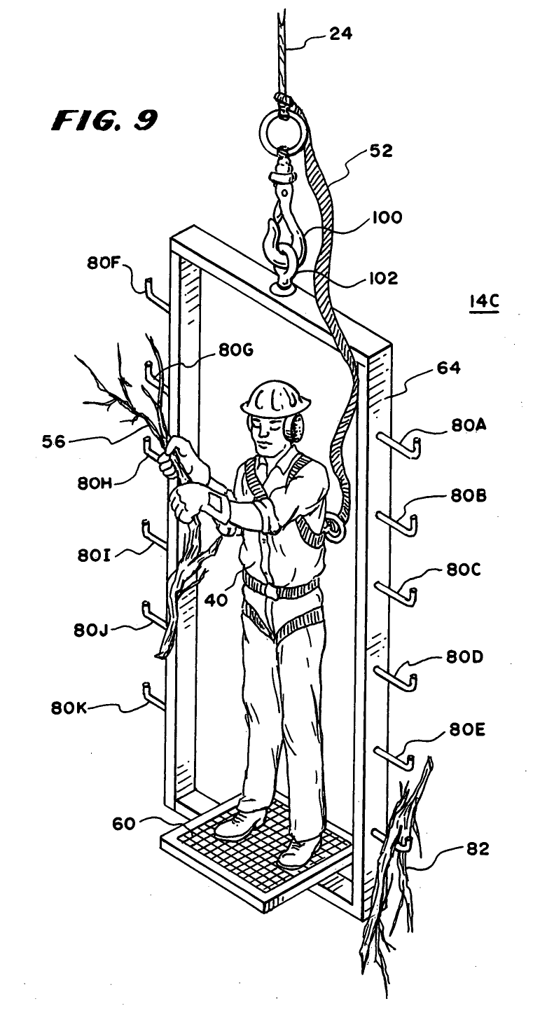

In FIG. 9, there is shown still another embodiment of tree trimmer station 14C showing the tree trimmer 40 on the tree trimmer platform 60 within the frame 64. The frame 64 is held by the winch load line 24. In this embodiment, the frame 64 rather than being a C-support as in the embodiment of FIG. 8 includes two sides, a bottom and a top. Along both sides extend hooks 80A-80K on which limbs may be hung for removal by a crane to a more convenient location.

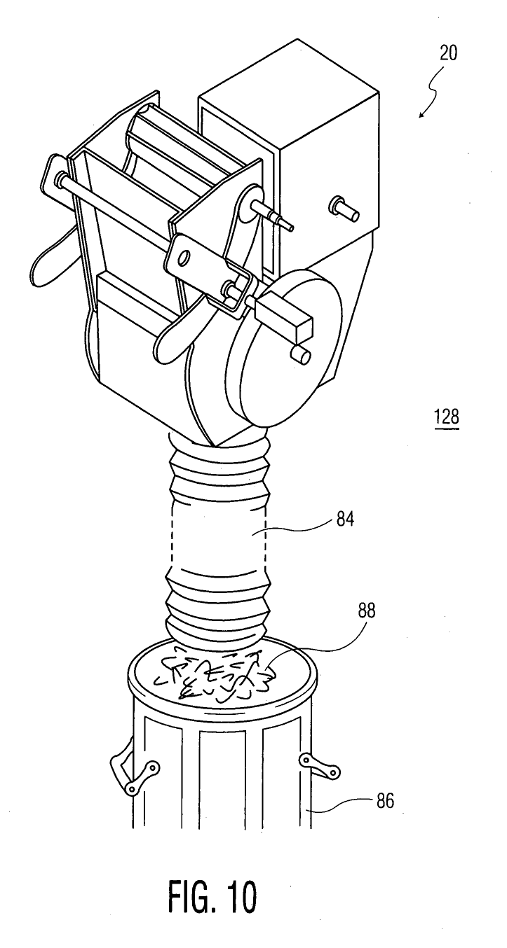

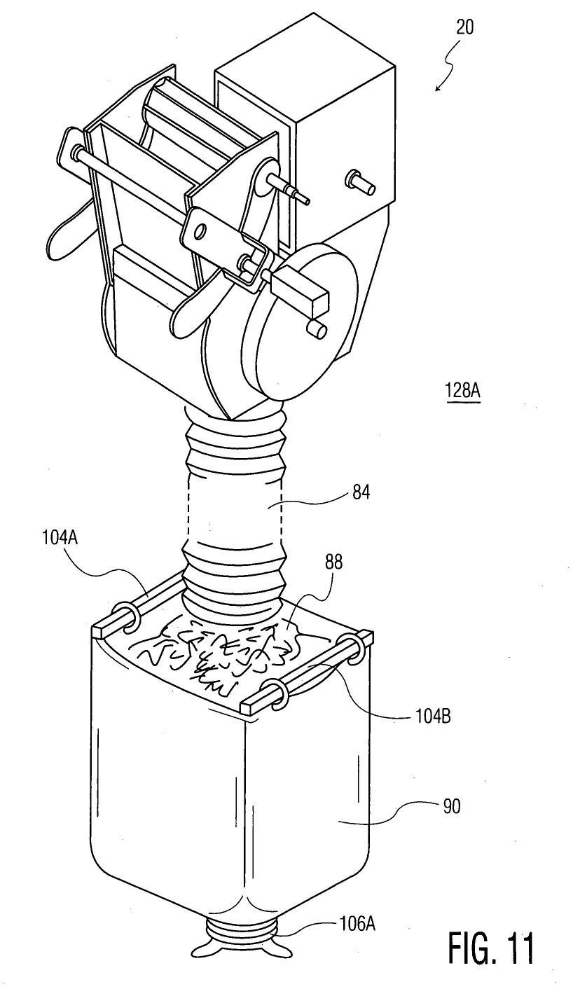

In FIG. 10, there is shown a simplified perspective view of a chip collection system 128 for collecting chips or other debris including a tube 84 having one end mounted adjacent to the outlet of a chipper 20 to receive chips and an outlet end positioned over a container 86 such as a steel container to receive chips 88 for removal from a location where a tree is being trimmed and chipped. In FIG. 11, there is shown still another chip collecting system 128A similar to the system 128 except that the outlet of the tube 84 is positioned adjacent to a canvas bag 90 rather than a metal container with the bag 90 having two parallel top poles 104A and 104B mounted on opposite sides of the canvas bag 90 to provide a convenient means for carrying the bag. At the bottom, the canvas is held together by pins 106A-106D (only 106A being shown in FIG. 11). With this arrangement, the chips may be removed such as by a crane pulling the top poles 104A and 104B and lifting the canvas bag 90 to a container where the pins 106A-106D may be removed to deposit the chips in the container.

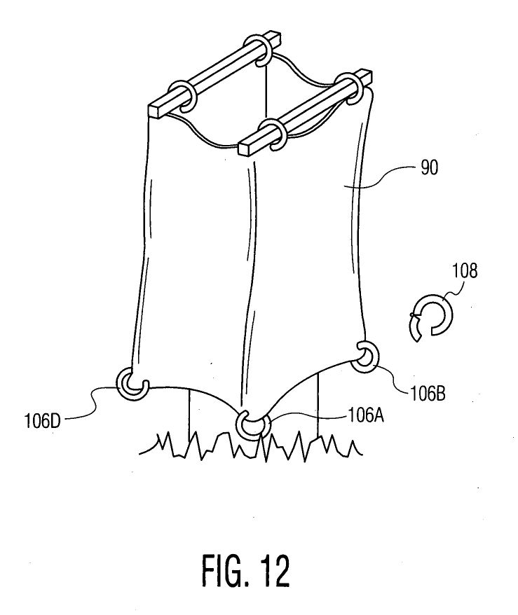

In FIG. 12, there is shown still another embodiment of bag 90 for receiving tree parts. In the embodiment of FIG. 12, the bag 90 contains hooks at each of four corners such as shown at 106A, 106B and 106D in FIG. 12. Those corners may be tied together by a clip or cord or other elongated member shown at 108. When the bag is full and to be opened such as in a pickup truck, the cord or clip 108 may be removed so as to permit the tree parts to drop from the bag 90.

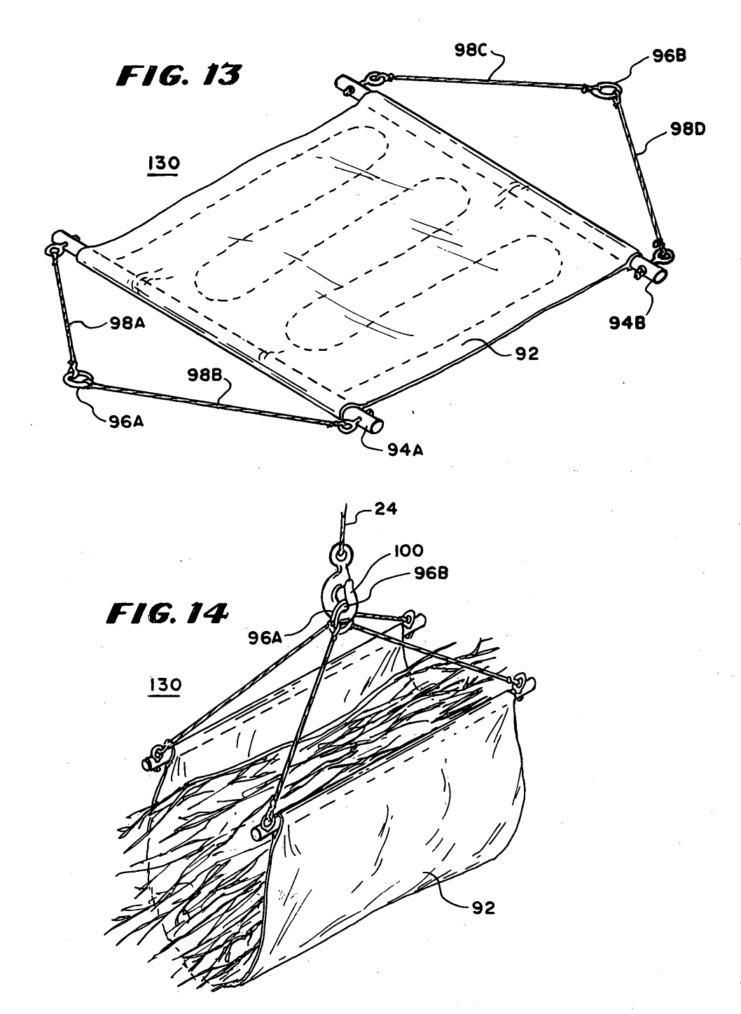

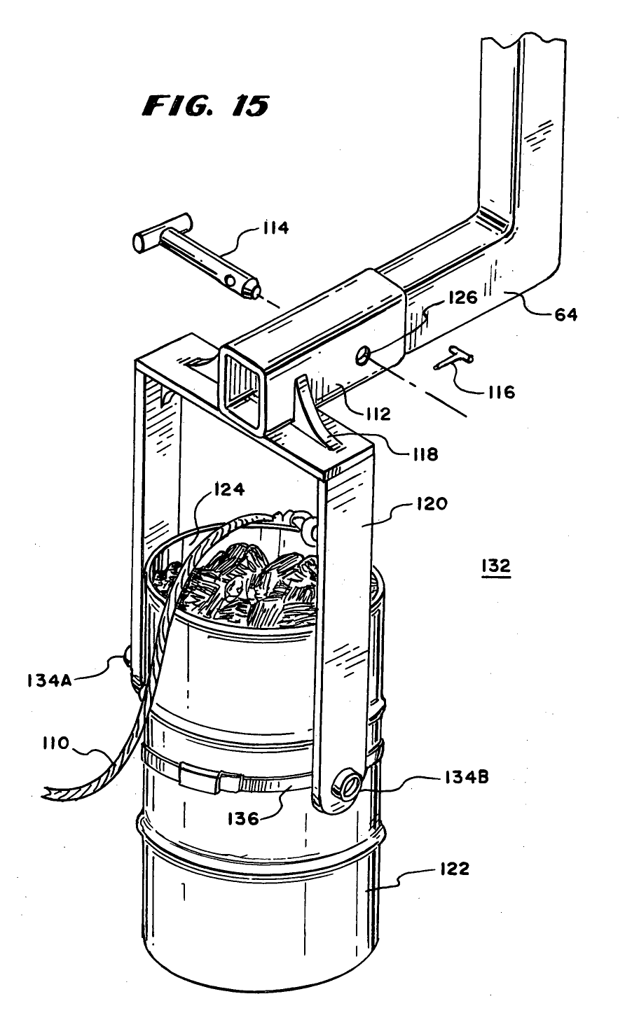

In FIGS. 13 and 14, there is shown two stages of a system 130 for removing limbs trimmed from a tree. In this system 130, the limbs are dropped below the tree into an open top 92 and in FIG. 14, the top is closed. More specifically, as shown in FIGS. 13 and 14, a canvas tarp includes two end poles 94A and 94B connected at their ends to a ring 96A and 96B respectively by ropes 98A and 98B being connected to ring 96A and connected to the opposite ends of the pole 94A and ropes 98C and 98D being connected to the ring 96B and connected to opposite ends of the pole 94B. With this arrangement, limbs may be stacked on the tarp and then the rings 96A and 96B pulled together and connected to the hook 100 of the winch load line 24 as best shown in FIG. 14. The crane may then move the tarp and the limbs to a more convenient location. While ropes are disclosed in FIGS. 13 and 14, any elongated flexible member may be used including canvas strips. Moreover, the tarp may be of any flexible strong sheet material.

In FIG. 15, there is shown a simplified perspective view of a system 132 for using a crane or cherry picker to deposit fill dirt over the ground beneath a tree that has just been trimmed to improve the appearance of the ground. This system 132 includes a fill dirt barrel or other container 122, a crane mounting fixture 112, and a frame 64 which in the embodiment of FIG. 15 is C-channel adapted to be moved by a crane in a manner described above. While a C-channel is shown in FIG. 15, any other means for attaching the fill dirt barrel to the crane may be utilized. The fill dirt barrel 122 is part of a gudgeon 120 mounted for pivotable motion about gudgeon pins 134A and 134B.

A rope 110 is attached at an upper location to a fill dirt barrel for pivoting about the gudgeon pins 134A and 134B to dump the dirt. The rope may be pulled by a tree trimmer either on the ground or carried by a position platform on the crane. The crane mounting fixture or sleeve 112 is held on the end of the frame 64 by a pin 114 which passes through aligned openings 126 in the frame 64, which is a C-channel, and through the sleeve 112. The sleeve 112 is connected such as by welding at 118 to the parallel arms of the gudgeon 120 to permit the lifting of the barrel 122 over the ground to be improved and spreading of the dirt over the ground. The gudgeon pins 134A and 134B may be connected to a band 136 about the barrel or may pass through openings in opposite sides of the fill dirt barrel 122.

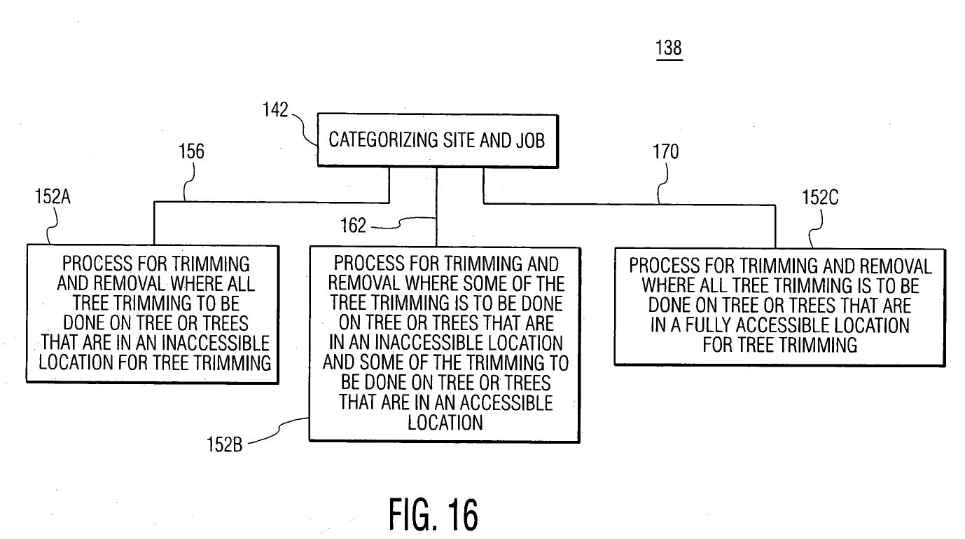

In FIG. 16, there is shown a flow diagram 138 of a process for tree trimming and removal of the tree parts including the step 142 of categorizing the site and the job leading to three different categories of procedures as indicated in the process lines 156, 162 and 170. The three processes are the process 152A for the trimming and removal of trees and tree parts where all the tree trimming is to be done on a tree or trees that are in an inaccessible location for tree trimming; (2) the process 152B for trimming and removal where some of the tree trimming is to be done on a tree or trees that are in an inaccessible location and some of the trimming and removal are to be done on a tree or trees that are in an accessible location; and (3) the process 152C for trimming and removal where all of the tree trimming is to be done on a tree or trees that are in a fully accessible location for tree trimming.

Accessibility is determined from the viewpoint of the ability to easily reach the tree or tree parts with the appropriate equipment. In general, an accessible location is a location where vehicles can be brought sufficiently close to the tree so that a cherry picker or a vehicle, such as a truck, for removing parts can be easily brought to the tree. An inaccessible location would generally be a location where there is an obstruction between access roads for the vehicles and the tree or trees to be trimmed. For example, a house may block the ability to reach a tree or trees with vehicles or a simple cherry picker and thus that tree or trees would be considered inaccessible.

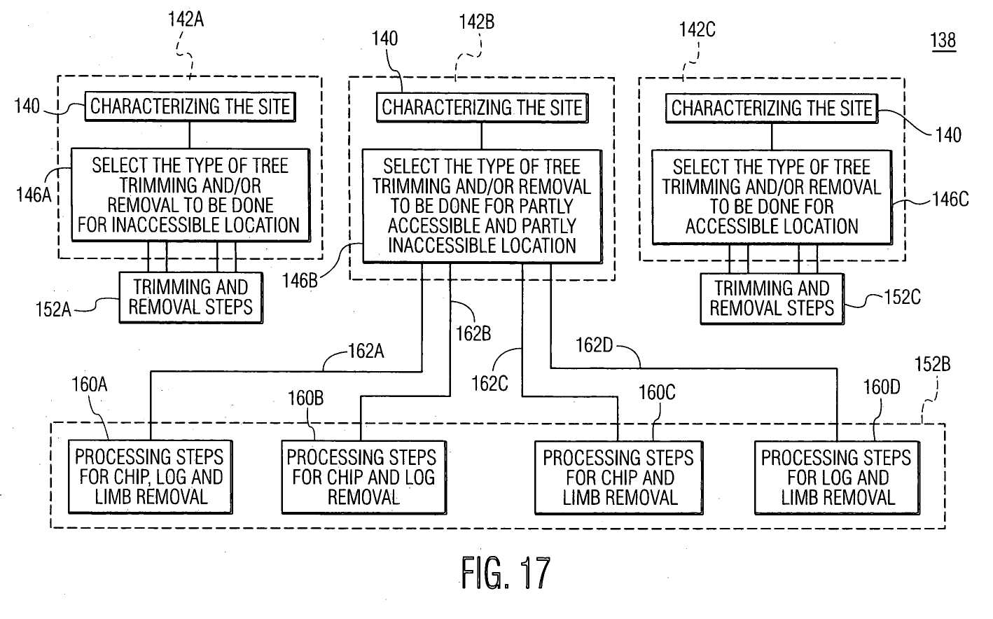

In FIG. 17, there is shown a flow diagram illustrating the steps of tree trimming 138 that encompasses all three characterizations of sites, which are: (1) the characterization of sites 142A for trimming and removal where all of the tree trimming is to be done on a tree or trees in an inaccessible location for tree trimming; (2) the characterization of sites 142B for trimming and removal where some of the tree trimming is to be done on a tree or trees that are in an inaccessible location and some of the trimming and removal is to be done on a tree or trees that are in an accessible location; and (3) the characterization of sites 142C where all of the trimming and removal of trees and tree parts is to be done on a tree or trees that are in a fully accessible location for tree trimming.

As shown in this view, the processes 142A-142C include the steps of characterizing the site 140 and the corresponding one of the steps 146A-146C of selecting the type of tree trimming and/or removal to be done for the inaccessible location, partly accessible and partly inaccessible location and fully accessible location. Once these processes are completed, then the corresponding one of the processes 152A-152C of trimming and removal is performed. The step 152B is broken down further into the processes 160A for chipping, log and limb removal, the processes 160B for chip and log removal only, the process 160C for chip and limb removal only and the process 160D for log and limb removal only. The processes of trimming and removal 152A and 152C include the similar steps 160A, 160B, 160C and 160D shown for 152B in greater detail. The processes 152A and 152C are shown as single blocks for simplicity rather than showing their four components as is the case with 152B. In this specification, the word “chip” means removing a smaller piece of feedstock from a larger by impacting the larger piece of feedstock with a cutting action in contrast to a shearing action or crushing action as in the case of hammer type chippers or wood hogs.

The process 138 of FIGS. 16 and 17 result in a decision on what equipment is to be brought to a site. This decision is based on whether the site of the tree or trees is inaccessible, partly accessible or completely accessible. This characterization of the site results in a decision to bring a crane to an inaccessible location for trimming as shown at 152A or to bring a crane alone or a crane and cherry picker to a partly accessible location for trimming as shown at 152 or to bring a crane or cherry picker to a completely accessible location as shown at 152C.

This characterization is useful because at times, the tree is a substantial distance from a roadway and may have obstacles such as a house in front of it. A crane may lift the tree trimmer over the obstacle and into the tree or may lower the tree trimmer downwardly by means of a winch. The load line of the winch may lower a tree trimmer station that includes a chipper attached to it or a tree trimmer station with only a tree trimmer mount or a tree trimmer station with different appliances for holding limbs or logs which may be removed later. Where there are multiple trees to be trimmed, some of them being some distance from the roadway and/or blocked by an obstacle and other trees that may be more accessible near a roadway, a crane may be used to work on both sets of trees or a crane may be used to work on the inaccessible trees and a cherry picker used for the accessible trees depending upon scheduling and equipment that is available. If all of the trees are accessible, the tree trimmer may choose either a crane or a cherry picker but it would be unlikely to utilize both of them because of the cost of moving the equipment and using two pieces of equipment when one would do. Even where the trees to be trimmed or stumps to be removed are all accessible, a crane has the advantage of superior degrees of freedom and reach. A cherry picker may need to be positioned at different locations on the property near the tree or trees that are to be worked on to reach all necessary locations and this may result in damage to the property such as damage to a lawn or shrubbery. A crane on the other hand may be able to reach all of the location from the street without moving because of the degrees of freedom of the boom and its reach.

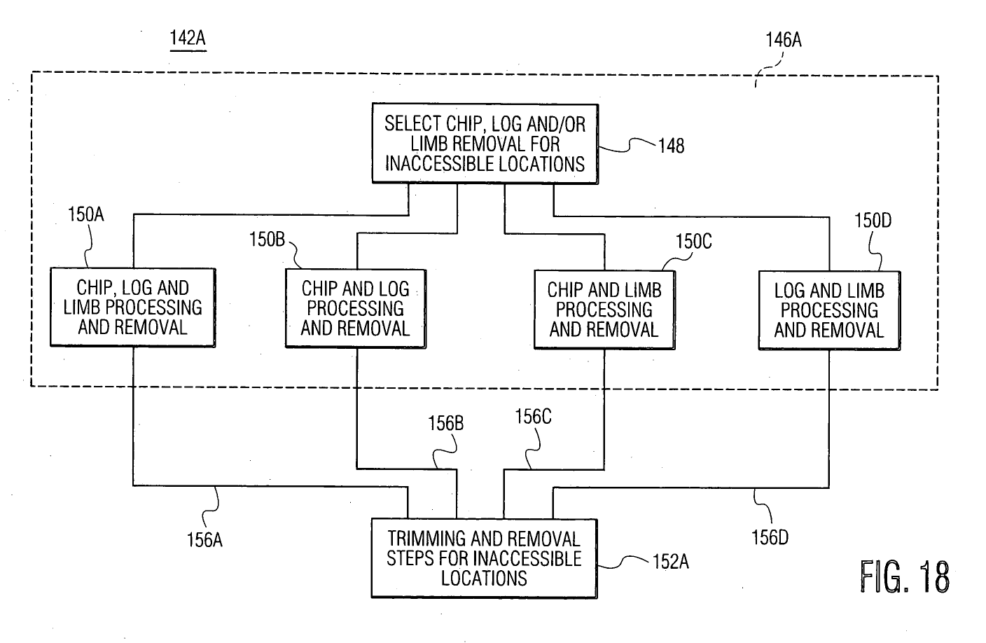

In FIG. 18, there is shown a flow diagram of the process 142A for trimming and removal of trees and tree parts where the work is to be done on a tree or trees that are in an inaccessible location for tree trimming having the subprocess 146A of selecting the type of tree trimming or removal work to be done and the subprocess 152A of performing the tree trimming and removal steps for inaccessible locations. The subprocess 146A of selecting the type of tree trimming or removal to be done includes the step 148 of selecting the type of work such as for example chipping, log preparation and removal and/or limb removal from the inaccessible location or locations. Depending on the type of work that is to be done, these jobs may be: (1) the step 150A of chipping, log and limb processing and removal; or (2) the step 150B of chip and log processing and removal only; or (3) the step 150C of chip and limb processing and removal only; or (4) the step 150D of log and limb processing and removal only. Each of these steps has its own trimming and removal steps for the inaccessible location as indicated by the process lines 156A, 156B, 156C or 156D.

The series of processes indicated in FIG. 18 enables decisions to be made on the equipment to be brought to a site and the flow of steps in using that equipment to accomplish the work. The equipment and steps differ from each job and site characterization to each job and site characterization. The tree trimmer decides on the equipment needed based on whether the site for the trees is entirely inaccessible, partly inaccessible and partly accessible or completely accessible and the nature of the work to be done at the site. The tree trimmer makes this assessment during an initial inspection by the tree trimmer before committing the equipment to the job. While in FIG. 18, only the process 142A for completely inaccessible trees and tree parts is shown, the processes are similar for sites with trees in partly accessible and partly inaccessible locations and in sites that are completely accessible.

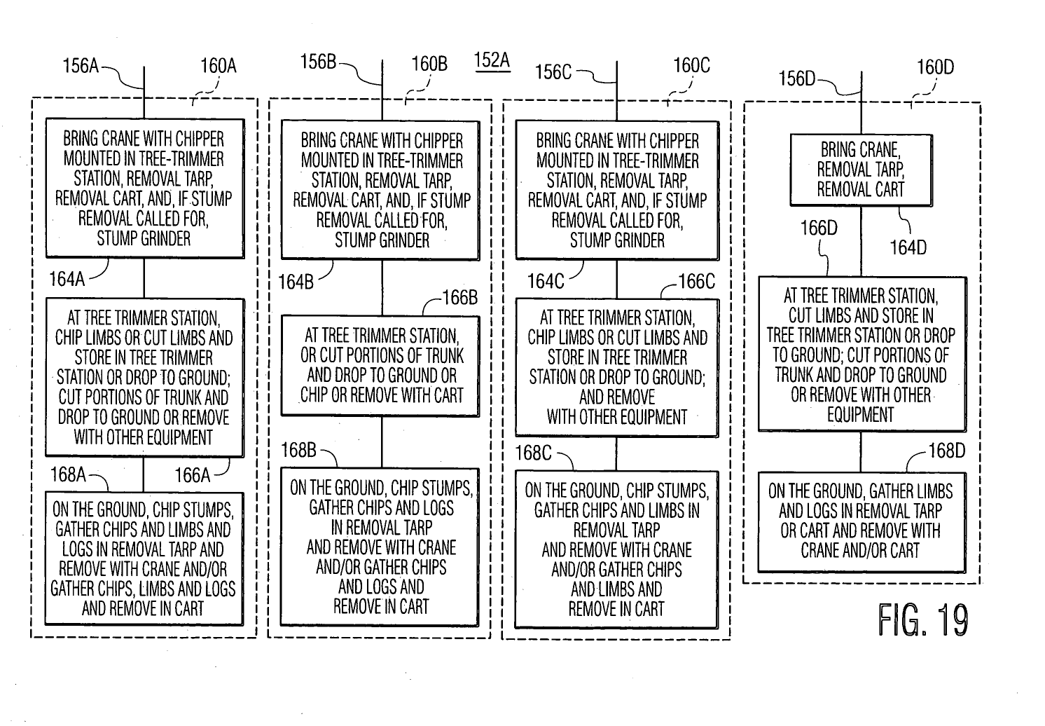

In FIG. 19, there is shown the processing and removal processes for inaccessible locations 152A having the subprocess 160A for chipping, log and limb removal, the subprocess 160B for chip and log removal only, the subprocess 160C for chip and limb removal only and the subprocess 160D for log and limb removal only. The subprocess steps 160A for chip, log and limb removal includes: (1) the step 164A of bringing a crane with a chipper mounted in the tree trimmer station, a removal tarp, a removal cart, and if stump removal is called for, a stump grinder or chipper to the site; (2) the step 166A of chipping limbs or cutting limbs and storing in the tree trimmer station or dropping the limbs to the ground, cutting portions of a trunk and dropping to the ground or for removal with other equipment at the tree trimmer station; and (3) the process 168A performed on the ground of chipping stumps, gathering chips and limbs and logs in a removal tarp and removing with a crane and/or gathering the chips, limbs and logs and removing in a cart. Preferably the step of bringing a stump grinder or chipper to the site comprises the step of bringing a stump grinder or chipper capable of vacuuming chips and having a chip confinement cover to limit the distribution of chips as they are formed so as to reduce clean-up time.

The process 160B of chip and log removal only includes the step 164B which is identical to the step 164A of process 160A since the same equipment is brought to the site for processing and removing chips and logs as for processing and removing chips, limbs and logs. The step 164B is followed by the step 166B in which portions of a trunk are cut and dropped to the ground or chipped and removed with other equipment followed by the step 168B in which the stumps are chipped and the chips and logs are gathered either in a removal tarp and removed with a crane or they are gathered and removed in a cart.

The process 160C for chip and limb removal only an inaccessible location includes: (1) the step 164C of bringing the crane with a chipper and limb holders mounted in the tree trimmer station, a removal tarp or cart, and if stump removal is called for, a stump grinder or chipper; (2) the step 166C of fastening the limbs to the tree trimmer station or dropping them to the ground for removal in a cart or other equipment such as the crane; (3) the step 168C of chipping stumps and if called for, and limbs, gathering the chips in a sack as the chipping is done for removal by the crane or on a tarp for removal by the crane and removing the limbs either in a cart if they were dropped to the ground or with the tree trimmer station if fastened to it.

The process 160D of log and limb removal only includes: (1) the step 164D of bringing a crane with limb fasteners and a log basket on the tree trimmer station, a removal tarp and/or removal cart to the site; (2) the step 166D of cutting the limbs at the tree trimmer station and either fastening them to the tree trimmer station with limb fasteners or dropping them in the basket and dropping logs into the basket for removal by the crane or if dropped to the ground for removal by a cart; and (3) the step 168D of gathering limbs and/or logs on the cart or on the tarp for removal on the cart or by crane if limbs were are dropped to the ground.

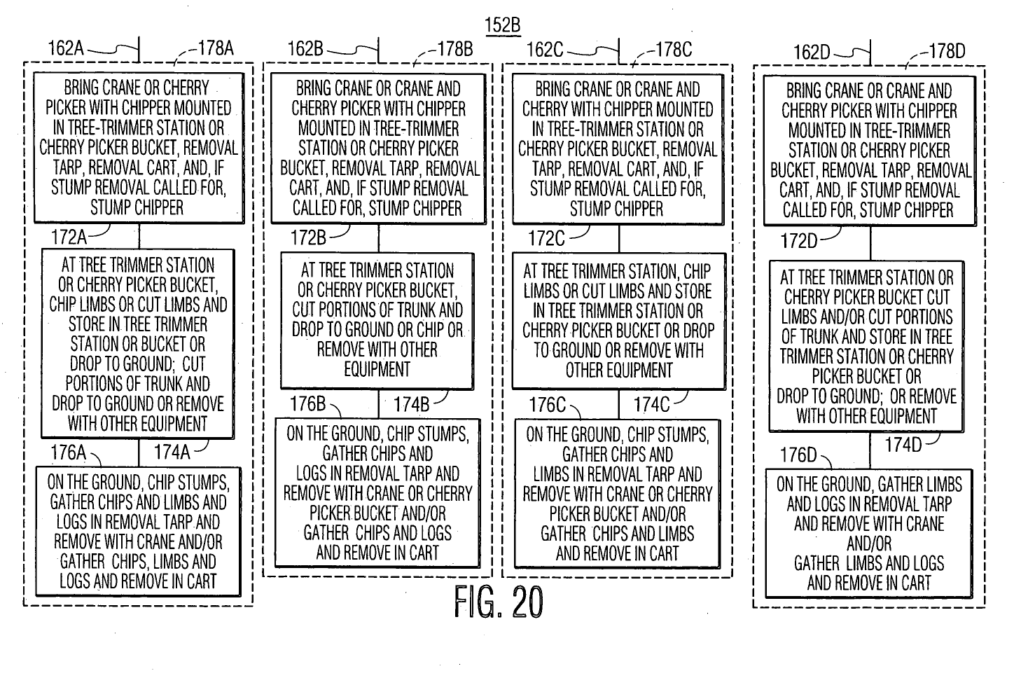

In FIG. 20, there is shown a flow diagram 152B of the process for trimming and removal of trees and tree parts at a site that is partly accessible and partly inaccessible having the process 178A for the processing and removal of chips, logs and limbs, the process 178B for the processing and removal of chips and logs only, the process 178C for the processing and removal of chips and limbs only, and the process 178D for the processing and removal of logs and limbs only.

The process 178A includes the step 172A of bringing a crane with a chipper mounted in the tree trimmer station, a removal cart, a removal tarp, if stump removal is called for, a stump grinder or chipper, and if there is substantial accessible work, at the option of the tree trimmer, a cherry picker can be brought and can also have a chipper mounted to the cherry picker bucket; (2) the step 174A of chipping the limbs or cutting the limbs and storing them in the tree trimmer station or dropping the limbs to the ground, cutting portions of the trunk and dropping to the ground or removing with other equipment or in a basket at the tree trimmer station for inaccessible trees or for accessible trees, cutting limbs and moving them into a truck or other storage or dropping them on the ground for moving to a truck and cutting portions of the trunk and loading it on a vehicle or chipping limbs and portions of the trunk on another vehicle or on the cherry picker bucket; and (3) the step 176A of chipping the stumps at ground level and gathering chips and limbs and logs in a removal tarp and remove with the crane for inaccessible locations and/or gather chips, limbs and logs and remove in a cart for either location or, move directly to a truck from a cherry picker.

The process 178B for chip and log processing and removal only includes: (1) the step 172B of bringing in a crane with a chipper mounted on the tree trimmer station and optionally a cherry picker with a chipper mounted on the bucket or in a vehicle which may either be the cherry picker vehicle or another vehicle, a removal tarp and a removal cart and if stump removal is called for, a stump grinder or chipper; (2) the step 174B of chipping limbs or cutting limbs and storing them in the tree trimmer station or dropping them to the ground at the inaccessible site and cutting portions of the trunk and dropping it to the ground or removing with other equipment; and (3) the step 176B of chipping stumps, gathering chips and limbs and logs in a removal tarp or bag connected to the chipper and removing with the crane or other vehicle on the ground.

The process 178C of processing and removing chips and limbs only includes: (1) the step 172C of bringing a crane with a chipper mounted at the tree trimmer station and optionally also bringing a cherry picker with chipper mounted to the bucket or another vehicle for holding the chipper and limbs and chips and if stump removal is called for, a stump grinder or chipper, a removal tarp or removal cart or both; (2) the step 174C of chipping limbs or cutting limbs and storing them in the tree trimmer station or bucket or dropping them to the ground and removing them with either a tarp and the crane or another vehicle; and (3) the step 176C of gathering chips and limbs in the removal tarp and removing with a crane and/or gathering chips and limbs and removing on a cart with a crane or cherry picker or other vehicle on the ground.

The process 178D for log and limb removal only includes: (1) the step 172D of bringing in a crane with a chipper mounted on the tree trimmer station and optionally a cherry picker with a chipper mounted on the bucket or in a vehicle which may either be the cherry picker vehicle or another vehicle, a removal tarp and a removal cart; (2) the step 174D of cutting limbs and storing them in the tree trimmer station or cherry picker bucket or dropping them to the ground at the accessible site and cutting portions of the trunk and dropping it to the ground or removing with other equipment; and (3) the step 176D of gathering limbs and logs in a removal tarp or bag and removing with the crane, cherry picker or other vehicle on the ground.

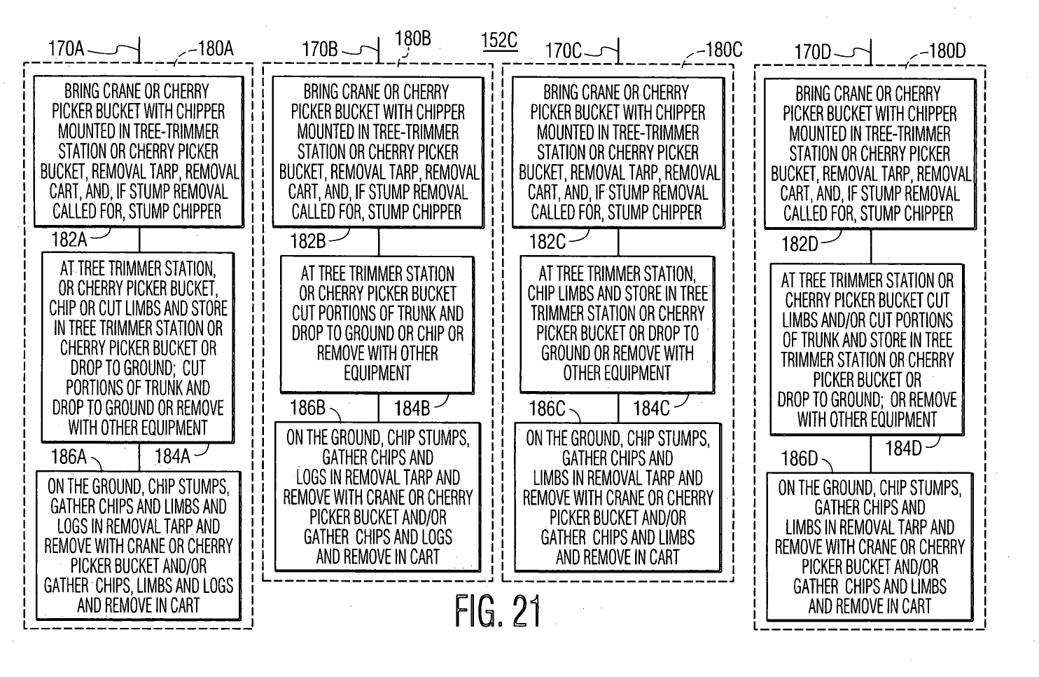

In FIG. 21, there is shown a flow diagram 152C of the process for trimming and removal of trees and tree parts at a site that is fully accessible having: (1) the subprocess 180A for the processing and removal of chips, logs and limbs; (2) the subprocess 180B for the processing and removal of chips and logs; (3) the subprocess 180C for the processing and removal of chips and limbs; and (4) the subprocess 180D for the processing and removal of logs and limbs.

The subprocess 180A includes: (1) the step 182A of bringing a crane with a chipper mounted in the tree trimmer station or a cherry picker with a chipper mounted on the bucket, a removal cart, a removal tarp, and if stump removal is called for, a stump grinder or chipper, (2) the step 184A of chipping the limbs or cutting the limbs and storing them in the tree trimmer station or dropping the limbs to the ground, cutting portions of the trunk and dropping to the ground or removing with other equipment or in a basket at the tree trimmer station, cutting limbs and moving them into a truck or other storage or dropping them on the ground for moving to a truck and cutting portions of the trunk and loading it on a vehicle or chipping limbs and portions of the trunk on another vehicle or on the cherry picker bucket; and (3) the step 186A of chipping the stumps at ground level and gathering chips and limbs and logs in a removal tarp and remove with the crane and/or gather chips, limbs and logs and remove in a cart for either location or, move directly to a truck from a cherry picker.

The subprocess 180B for chip and log processing and removal only includes: (1) the step 182B of bringing in a crane with a chipper mounted on the tree trimmer station or a cherry picker with a chipper mounted on the bucket or in a vehicle which may either be the cherry picker vehicle or another vehicle, a removal tarp and a removal cart and if stump removal is called for, a stump grinder or chipper; (2) the step 184B of chipping limbs or cutting limbs and storing them in the tree trimmer station or dropping them to the ground and cutting portions of the trunk and dropping it to the ground or removing with other equipment; and (3) the step 186B of chipping stumps, gathering chips and logs in a removal tarp or bag connected to the chipper and removing with the crane or other vehicle on the ground.

The subprocess 180C of processing and removing chips and limbs only includes: (1) the step 182C of bringing a crane with a chipper mounted at the tree trimmer station or a cherry picker with chipper mounted to the bucket or another vehicle for holding the chipper and limbs and chips and if stump removal is called for, a stump grinder or chipper, a removal tarp or removal cart or both; (2) the step 184C of, at the tree trimmer station or the bucket of a cherry picker, chipping limbs or cutting limbs and storing them in the tree trimmer station or bucket or dropping them to the ground and removing them with either a tarp and the crane or another vehicle; and (3) the step 186C of gathering chips and limbs in the removal tarp and removing with a crane and/or gathering chips and limbs and removing on a cart with a crane or cherry picker or other vehicle on the ground.

The subprocess 180D for log and limb removal only includes: (1) the step 182D of bringing in a crane with a chipper mounted on the tree trimmer station or a cherry picker with a chipper mounted on the bucket or in a vehicle which may either be the cherry picker vehicle or another vehicle, a removal tarp and a removal cart; (2) the step 184D of cutting limbs and storing them in the tree trimmer station or cherry picker bucket or dropping them to the ground at the accessible site and cutting portions of the trunk and dropping it to the ground or removing with other equipment; and (3) the step 186D of gathering limbs and logs in a removal tarp or bag and removing with the crane or cherry picker or other vehicle on the ground.

In FIG. 22, there is shown an exploded perspective fragmentary view of the chipper 20 having a feed inlet 188, a feed drum 190, a grinder drum or chipping drum 192 and an outlet 194. The feed drum 190 is mounted just below the feed inlet 188 and communicates with a thickness adjustment fixture 202. The thickness adjustment fixture 202 includes a handle 208 mounted to a lever arm 210 to pivot about a pivot point 212 to move within an arc slot 214 in a side panel 302. It communicates with an axle 216 of the feed drum 190. The feed drum 190 includes a plurality of protruding ridges 198 spaced apart around its periphery extending for the length of its periphery to pull limbs, leaves and other parts of a tree downwardly against the grinder drum 192. The feed inlet 188 is framed by the sides 302, 304 and 306. The side 306 includes a parallel arc 310 for movement of the opposite end of the axle 216. The grinder drum 192 includes a drive axle 308 and a plurality of teeth 200A-200C being shown as examples in FIG. 22. The outlet 194 has an outlet screen 204 with a plurality of openings in it to hold larger tree parts for further grinding while permitting the tree parts that have already been ground smaller to drop through it. The motor 196 includes an output axle 206 connected by suitable drive belts to the axle 308 of the grinder drum 192 and to the axle of the feed drum 190 to drive them (not shown in FIG. 22).

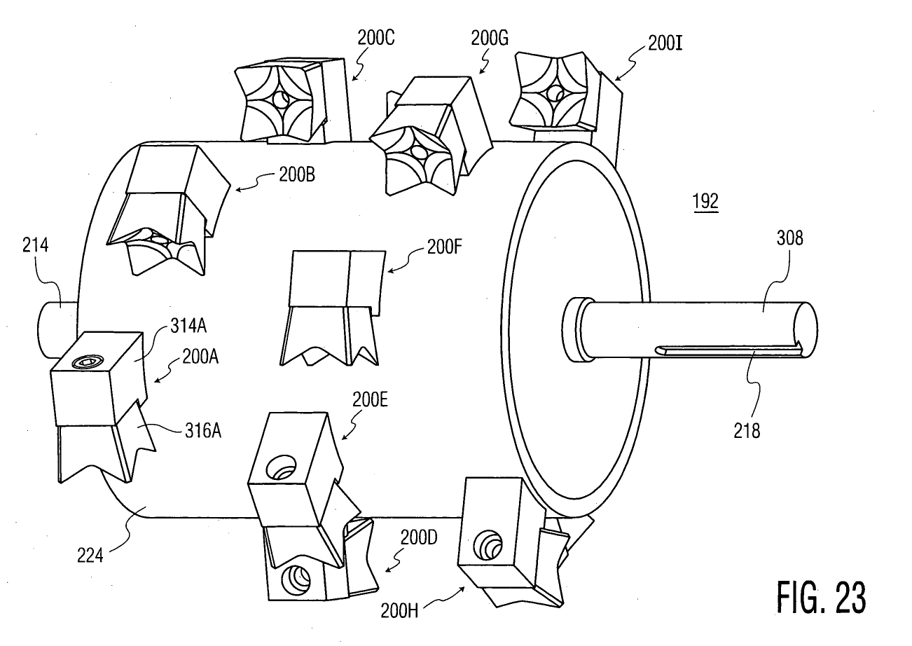

In FIG. 23, there is shown a perspective view of a grinder drum or chipping drum 192 having a drive axle 308 with a key 218 along a portion of its length and a peripheral surface or working surface of the grinder drum 192 having circumferentially spaced teeth 200A-200I along its periphery. Any number of teeth may be utilized and the teeth 200A-200I are given as examples. However, the positioning of the teeth is selected to avoid excessive friction. For this purpose, a line parallel to the axle or longitudinal axis 192 of the drum must not pass through chipping surfaces of such a length as to create excessive resistance to rotation during chipping. It must be less than one-third the peripheral surface of the drum along that line.

Each of the teeth includes a holder portion such as 314A welded to the peripheral surface or working surface of the grander drum 192 and a tooth portion 316A. The tooth portions such as 316A are bolted to the holder portions such as 314A for ease in replacement when worn or for substitution of different style teeth. The teeth in the preferred embodiment are rectangular with slightly pointed corners but any configuration may be utilized provided they are thick multi-pointed teeth. In this specification, the words, “thick multi-pointed teeth” means that there is no dimension tangential to the circumference of the drum and substantially perpendicular to the radius of the drum which is smaller than ⅛ of an inch except for protruding points. No protruding pointed area extends less than ½ the diameter of the tooth so that there are multi points that chip at the wood, all of which have substantial strength so as not to be easily rendered ineffective by breaking or wearing quickly from excessive pressure exerted by the wood in the manner of knives. The points are connected by curved surfaces. They are intended to be moved more rapidly than knives against the wood portions.

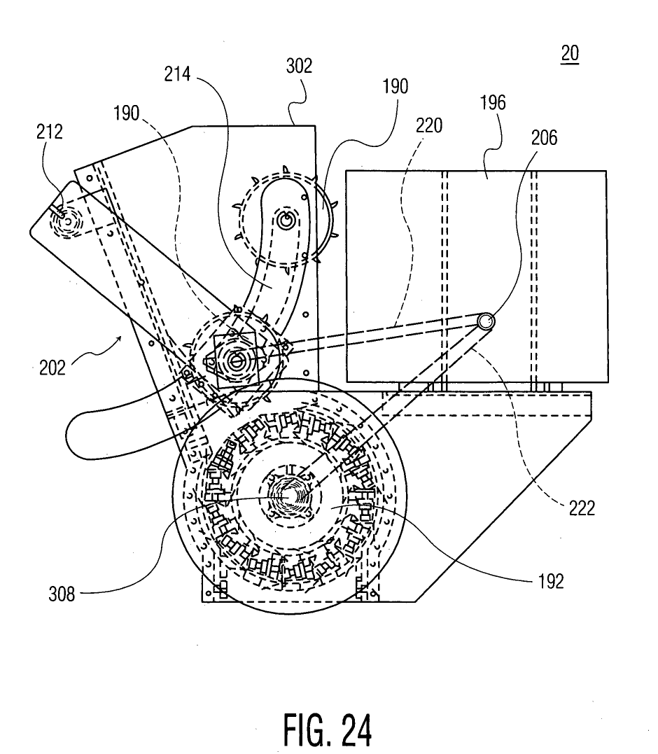

In FIG. 24, there is shown a side view of the chipper 20 showing the motor 196, the adjustment fixture 202, the grinder drum 192 and the feed drum 190. The feed drum 190 and the grinder drum 192 are driven from the output axel 206 by the belts 312 and 318.

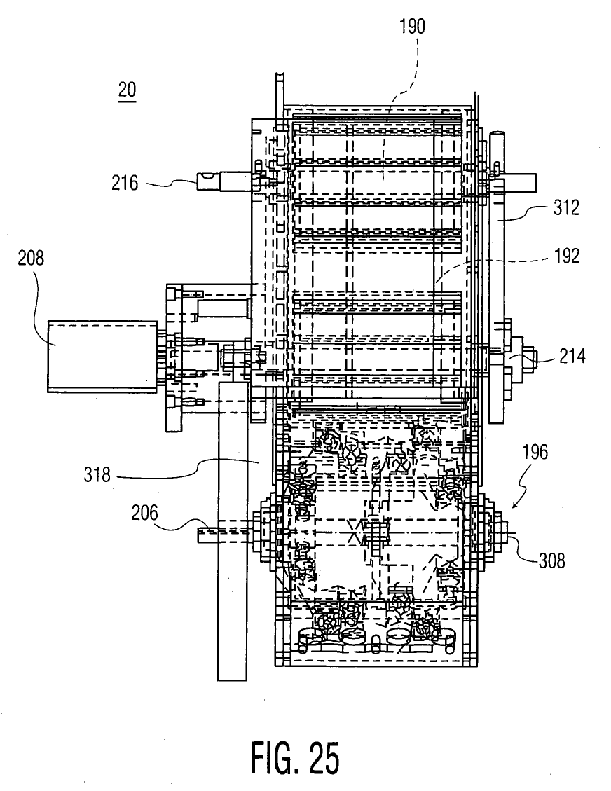

In FIG. 25, there is shown a side view of the chipper 20 having the feed drum 190, the grinder drum 192 and the motor 196. As shown in this view, the axel 206 of the motor 196 drives the belt 318 communicating between the axel 206 of the motor 196 and the axel 216 of the feeder drum 190. Similarly, the drive axle 308 drives the axle 216 of the feeder drum through the belt 312. The peripheral motion of the grinder drum 192 is substantially greater than that of the feeder drum 190, because of its larger diameter. It is also possible through gearing or other mechanical advantage devices to make the ratio of the speeds still greater. It is advantageous when utilizing the teeth of this invention to have a high peripheral speed of the teeth against the tree parts that are being reduced in size.

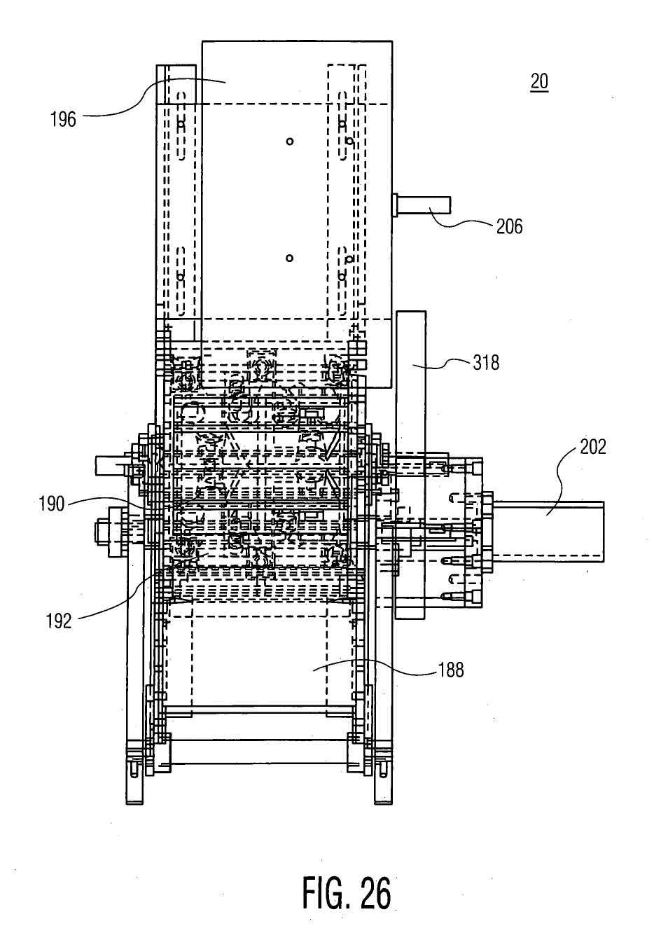

In FIG. 26, there is shown a top view of the chipper 20 showing the inlet 188 through which parts of the tree are fed with the feed motor 190 engaging them and moving them into the teeth of the feed grinder 192. As shown in this view, tree parts may be easily fed from above such as at a tree trimmer's station and be ground to be dropped to a container below.

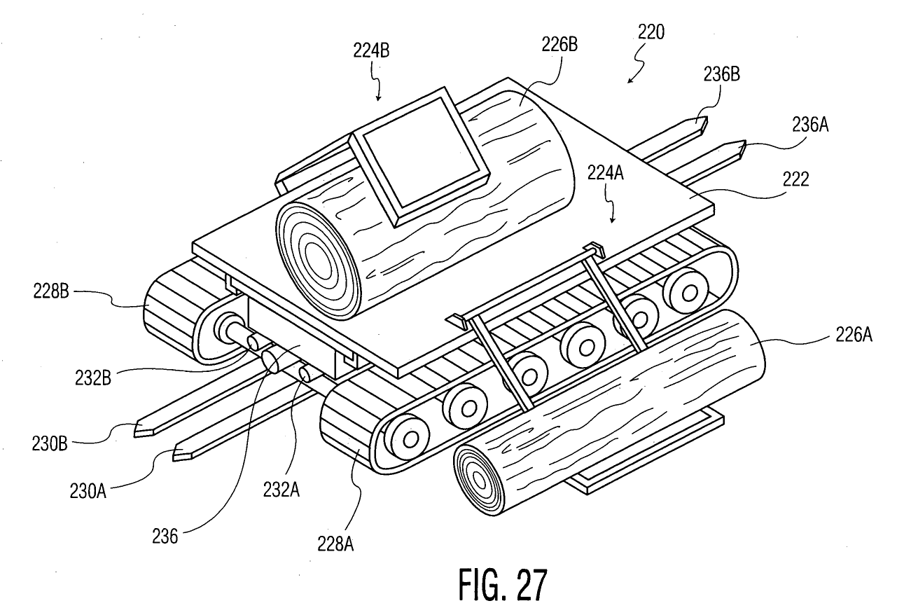

In FIG. 27, there is shown a simplified perspective view of a cart 220 having a top surface or central section of platform 222, two side actuators 224A and 224B, two side sections 225A and 225B mounted to be folded over the central section and two front forklift members 230A and 230B mounted to be extended through the front and two forklift members 236A and 236B mounted to be extended rearwardly and driven by actuators such as 232A and 232B shown in the front of the cart. The tractor treads 228A and 228B are driven by a forwardly positioned motor 236 under remote control of an operator and steerable by differential speed. With this arrangement, the cart may be relatively narrow to pass into backyards and yet have substantial carrying load because of the extending forks. In this specification, the word “actuator” includes screw driven actuators or hydraulic cylinders or gear driven actuators or their equivalents.

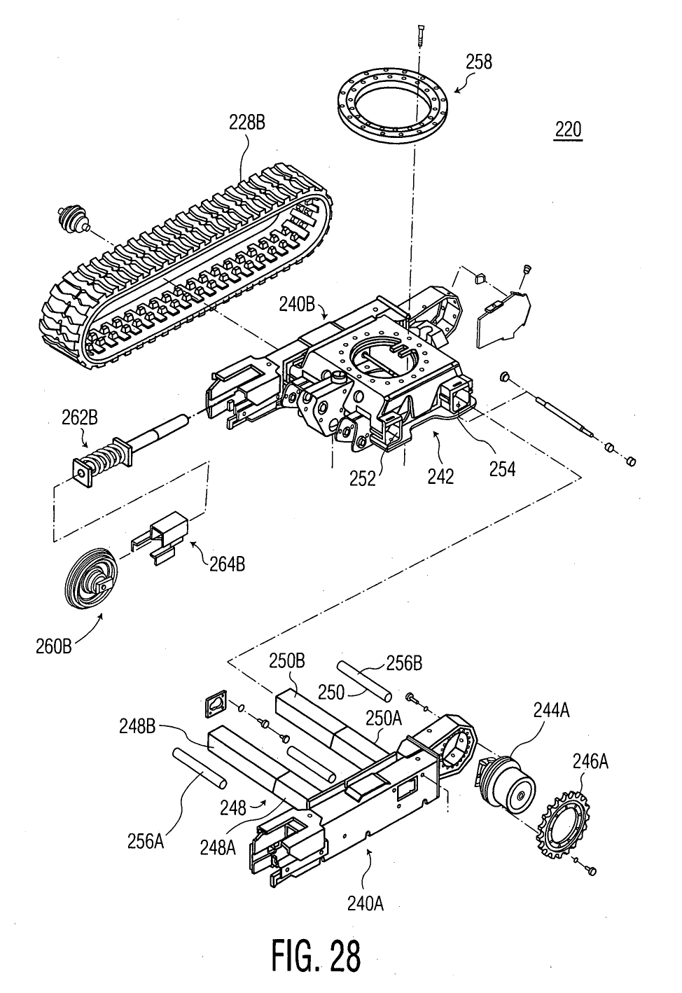

In FIG. 28, there is shown a simplified, fragmentary exploded perspective view of the cart 220 of FIG. 27 having the left hand tractor tread 228B, right and left hand side frame members 240A and 240B, a center frame member 242, a right hydraulic drive motor 244A and a right sprocket wheel 246A. The right and left frame member 240A and 240B are adjustable in the distance between them and each supports a right tread 228A (shown in FIG. 27) and a left tread 228B. Hydraulic motors such as the right hydraulic motor 244A drive sprocket wheels such as the sprocket wheel 246A to independently move their respective ones of the treads 228A (shown in FIG. 27) and 228B. Changes in the speeds between the two may be used to steer the cart 220.

To adjust the distance between the treads 228A and 228B, the frame member 240A includes first and second adjustable, telescoping parallelepiped shafts 248 and 250. Each of the shafts 248 250 is composed of two telescoping parts such as 248A and 248B for the shaft 248 and two telescoping parts such as 250A and 250B for the shaft 250. These shafts pass through corresponding support openings 252 and 254 in the center frame 242 and are mounted to the side frame member 240B. A hydraulic cylinder 256 is mounted at one end to the side frame 240A and at the other end to the side frame 240B and may adjust the distance between the treads 228A and 228B to permit the cart 220 to move through narrow gates such as a standard garden gate which is 30 inches wide. For this purpose, the treads 228A and 228B may be spaced so that their outer distances are only 24 inches and then may be expanded to a much larger width with a top surface the of collapsible platform 222 (FIG. 27) to permit a heavier load to be loaded onto the cart.

The top surface of platform 222 (FIG. 27) rests on a roller bearing 258 that in turn rests on center frame member 242. Roller bearings 260A and 260B (260B being shown in FIG. 28) are mounted to opposite sides of the center frame 242 by spring assemblies 262A and 262B (262B being shown in FIG. 28) by a yoke 264A and 264B (264B being shown in FIG. 28). Various cover plates are also used for openings as needed.

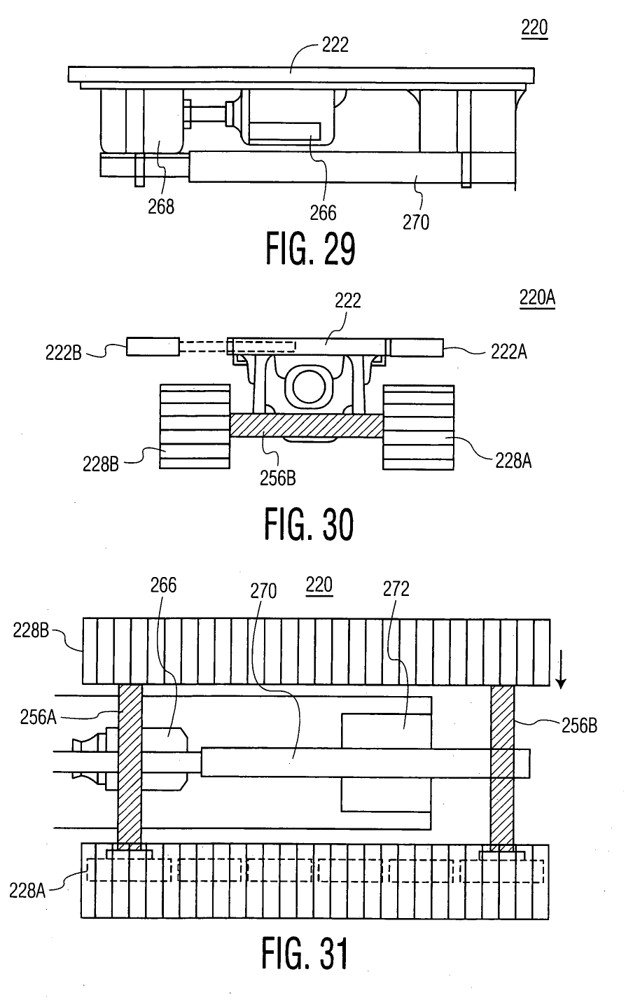

In FIG. 29, there is shown a fragmentary side view of the retractable undercarriage for the cart 220 having an engine 266 mounted to drive a pump 268 both of which are mounted to be moved with respect to the top surface or platform 222 (see FIG. 27) by a hydraulic cylinder 270 so that they may be moved forwardly beyond the treads 228A and 228B (FIGS. 27 and 28) so that the treads may be moved closer together.

In FIG. 30, there is shown another embodiment of cart 220A which has the same parts as the cart 220 and are labeled the same except that the top surface or platform 222 includes side members 222A and 222B which may be slid telescopically under the platform 222 when the cart is moving through a narrow gate with the treads 228A and 228B retracted. In this manner, the cart may be moved through narrow gates when desired. This is an alternative to the embodiment 220 in which actuators are mounted on the sides of the platform 222 to move upwardly so that the cart may move through a narrow gate.

In FIG. 31, there is shown a bottom view of the cart 220 showing the manner in which the hydraulic cylinder 270 may move the engine 266 forwardly beyond the treads 228A and 228B to permit the treads 228A and 228B to be moved together. By the motion of hydraulic cylinders 256A and 256B, a fuel tank 272 may supply fuel through hoses to the engine 266.

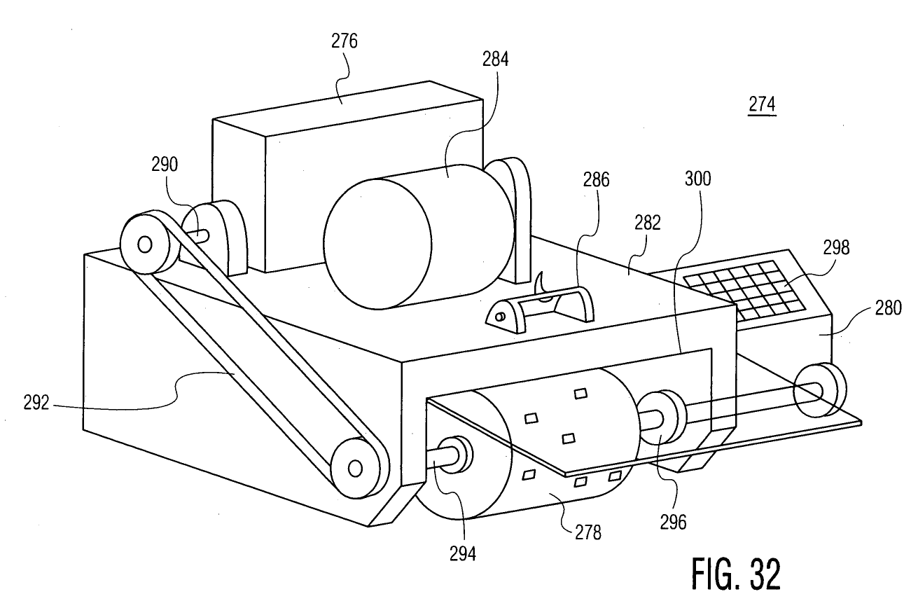

In FIG. 32, there is shown a perspective view of a stump grinder or chipper 274 having a drive motor 276, a chipper drum or rotatable fragmenting device 278, a chip removal compartment or particle collector 280 and a chip confinement compartment or housing 282. The chip confinement compartment or housing 282 mounts the drive motor 276 and a fuel tank 284 as well as a winch mount 286 or other mounting means by which the stump grinder or chipper 274 may be moved into place such as by a crane or any other suitable means to drive the chipper drum 278, an output shaft 290 communicates through a drive belt 292 with a drive shaft 294 of the chipper drum 278. The drive shaft 294 also communicates with a blower fan 296 to draw chips or other refuse into the compartment 280. A vent 298 in the compartment 280 permits the escape of air but is grated to hold the chips within the compartment 280 for removal. A translucent or transparent plastic door or open means 300 may be used to close the compartment 282. With the door open, the chipper 274 may be moved against a stump laterally or with the door closed may be moved over the top of a stump to grind the stump into chips. The chips will be pulled into the closed compartment 280 which has a bottom section that is fully enclosed unlike the compartment 282 which has an open bottom. With this arrangement, the clean up of chips is substantially reduced after the stump has been reduced to below ground level.

From the above description it can be understood, that the tree trimming procedure and equipment of this invention has several advantages, such as: (1) they substantially increase the safety of tree trimming; (2) they substantially reduce the time of clean up; (3) they enable relatively easy chipping of limbs and the like or removal of limbs using a crane from inaccessible locations; (4) they reduce the time required to chip limbs by chipping them right from the tree if desired; (5) they permit easy removal of limbs or other tree parts through the use of a cart; and (6) they provides a very flexible system for tree trimming that can accommodate difficult to reach locations, locations where some of the trees may be difficult to reach and others not and readily accessible locations.

Although a preferred embodiment of the invention has been described in some detail, many modifications and variation in the preferred embodiment are possible without deviating from the invention. Therefore, it is to be understood that, within the scope of the appended claims the invention may be practiced other than as specifically described.

What is claimed is:

1. A wood working implement for chipping feedstock, comprising;
an opening for receiving the feedstock;
a feed drum;
a chipping drum having a chipping drum working surface with a predetermined working surface length;
said feed drum being positioned to move the feedstock to the chipping drum;
said chipping drum including a longitudinal axis about which the chipping drum rotates;
said chipping drum including a plurality of spaced-apart teeth, wherein the length of a line parallel to the longitudinal axis and passing through at least one of the plurality of spaced-apart teeth extends through the at least one of the plurality of spaced-apart teeth a total distance less than one third the length of the predetermined working surface parallel to the longitudinal axis, whereby force resisting rotation of the chipping drum is reduced;
said plurality of spaced-apart teeth being positioned to impact the feedstock as the chipping drum rotates and to separate a smaller piece of the feedstock from a larger piece.

2. A wood working implement in accordance with claim 1 wherein said plurality of spaced-apart teeth include:
a plurality of tooth holders welded to a surface of the chipping drum;
said plurality of tooth holders having openings wherein teeth may be bolted to them;
at least some of said teeth being thick multipointed teeth in which the points are connected by curved surfaces.

3. A method of chipping feedstock, comprising the steps of:
inserting the feedstock into a feedstock opening in a feedstock chopper;
chipping the feedstock with a chipping drum having a chipping drum working surface with a predetermined working surface length and a longitudinal axis about which the chipping drum rotates wherein said chipping drum including a plurality of spaced-apart teeth with the length of a line parallel to the longitudinal axis and passing through at least one of the plurality of spaced-apart teeth extending through the at least one of the plurality of spaced-apart teeth a total distance less than one third the length of the predetermined working surface parallel to the longitudinal axis, whereby force resisting rotation of the chipping drum is reduced;
the step of chipping the feedstock comprises the steps of cutting a smaller portion of the feedstock from a larger portion.

4. A method in accordance with claim 3 wherein the chipping drum is rotated at a high rate of speed.

5. A method in accordance with claim 4 in which the chipping drum is rotated at a speed of at least 1500 rpm.

6. A cart for removing tree parts, comprising:
a platform;
said platform being supported by rotatable means for permitting movement of the cart;
cart side extensions that may be extended and retracted whereby the cart may pass through narrow passageways when said platform is extended and be extended to hold more tree parts.

7. A cart in accordance with claim 6 wherein said rotatable means includes treads.

8. A cart in accordance with claim 7 further including drive means for increasing and decreasing the distance between side by side rotatable means wherein the cart may move through narrow passageways and have a wider support base during loading.

9. A method of removing tree parts, comprising the steps of:
moving a cart through a narrow passageway while cart parts of the cart are retracted;
extending the retracted cart parts; and
loading tree parts onto the cart while the cart parts are extended.

10. A method in accordance with claim 9 further including the steps of retracting the cart parts while the cart is loaded and moving the cart through the narrow passageway.

11. A method in accordance with claim 10 wherein the step of retracting the cart parts comprises the step of folding the cart parts toward the cart.

12. A stump grinder, comprising;
a rotatable fragmenting device having surfaces for fragmenting stumps into smaller wood particles;
a housing;
said rotatable fragmenting device being within the housing;
said housing having an open means permitting the rotatable fragmenting device and stump to be brought into contact while the rotatable fragmenting device is at least partly enclosed by the housing, whereby the smaller wood particles are confined within the housing; and
a particle collector for collecting the particles.

13. A stump grinder in accordance with claim 12 in which the particle collector includes means for moving the smaller particles into an enclosure.
